(19) United States
(12) Patent Application Publication
(10) Pub. No.: US 2006/0187164 A1
(43) Pub. Date: Aug. 24, 2006

(54) Liquid crystal display device performing dot inversion and method of driving the same

(76) Inventor: Takeshi Okuno, Suwon-si (KR)

Correspondence Address: CHRISTIE, PARKER & HALE, LLP, PO BOX 7068, PASADENA, CA, 91109-7068, US

(21) Appl. No.: 11/330,730

(22) Filed: Jan. 11, 2006

(30) Foreign Application Priority Data
Feb. 23, 2005 (KR) 2005-15112

(51) Int. Cl. G09G 3/36

(52) U.S. Cl. 345/92

(57) ABSTRACT

An LCD device for performing a dot inversion and a method of driving the same. A storage line is provided separately from a common electrode line so that a level of a storage voltage applied through the storage line can be shifted once per frame. As the storage voltage is shifted using the storage line, the polarity of a voltage applied to a pixel electrode of a liquid crystal is inverted. One such storage line is provided per line of the pixels and storage capacitors of the pixels disposed above and below the storage line are alternately connected to the storage line.

### CROSS-REFERENCE TO RELATED APPLICATION

This application claims priority to and the benefit of Korean Patent Application No. 10-2005-0015112, filed Feb. 23, 2005, the entire content of which is incorporated herein by reference.

### BACKGROUND OF THE INVENTION

1. Field of the Invention

The present invention relates to a liquid crystal display (LCD) device, and more particularly, to an LCD device that performs a dot inversion.

2. Description of the Related Art

An LCD device uses optical anisotropy and polarization properties of liquid crystal molecules. Particularly, in the case of an active matrix LCD, a thin film transistor (TFT) and a pixel electrode connected to the TFT are used to control an orientation of the liquid crystal molecules.

The TFT includes a gate electrode connected to a scan line, such that the TFT is turned on and off by a scan signal applied through the scan line. Further, the TFT includes a first electrode connected to a data line and a second electrode connected to the pixel electrode. The liquid crystal (or liquid crystal layer) is sandwiched (or disposed) between the pixel electrode and a common electrode and sealed up using a predetermined sealing material.

A data voltage is applied through the data line connected to the first electrode of the TFT, and a storage capacitor is used to maintain the orientation of the liquid crystal molecules for a predetermined period. The storage capacitor is electrically connected between the pixel electrode and the common electrode in parallel with the liquid crystal.

In a typical active matrix LCD, the orientation of the liquid crystal molecules is determined by a difference between the data voltage applied through the data line and a common voltage applied to the common electrode, and a predetermined image is displayed using a light source that emits light from behind the liquid crystal.

When a direct current (DC) voltage is applied to the liquid crystal sandwiched between the pixel electrode and the common electrode for more than a predetermined duration, the properties of the liquid crystal are likely to deteriorate. Accordingly, various polarity inversion methods, which periodically reverse the polarity of a voltage applied to the liquid crystal, have been proposed to prevent such deterioration.

Examples of such polarity inversion methods include a frame inversion method, a line inversion method, a column inversion method, and a dot inversion method.

In the frame inversion method, the polarity of the voltage applied to the liquid crystal molecules between the common electrode and the pixel electrode is repeatedly reversed frame by frame. For example, a positive (+) voltage is applied to the liquid crystal molecules corresponding to all pixels in a first frame, and a negative (−) voltage is applied to the liquid crystal molecules corresponding to all pixels in a second frame. However, here, a transmittance between the successive frames is asymmetrical, which may cause flicker. Further, this method is vulnerable to crosstalk due to interference between adjacent data.

In the line inversion method, the polarity of the voltage applied to the liquid crystal is repeatedly inverted line by line. For example, in one frame, a positive (+) voltage is applied to the liquid crystal corresponding to odd-numbered scan lines and a negative (−) voltage is applied to the liquid crystal corresponding to even-numbered scan lines. Consequently, the polarities of the adjacent scan lines are opposite to each other. However, horizontal crosstalk is likely to occur because the voltage having the same polarity is distributed to the horizontally arranged pixels.

In the column inversion method, the polarities of voltages applied to the liquid crystal are the same in the direction of the data line but opposite in the direction of the scan line. This decreases horizontal crosstalk compared to the line inversion method. However, a source driver for generating a high voltage is additionally needed to apply the data voltages of opposite polarities to adjacent data lines.

In the dot inversion method, the polarities of voltages applied to adjacent pixels are opposite in all directions. Such a dot inversion method yields the best picture quality but consumes much more power than the aforementioned other inversion methods.

In a dot inversion method disclosed in Korean Patent Publication No. 2004-0008652, the voltage of a common source applied to the common electrode is inverted. However, when dot inversion is performed by inverting the voltage of the common source applied to the common electrode, there are various limitations. For example, the storage capacitor provided in each pixel should be connected to the common electrode, and thus a contact hole should be formed to connect the storage capacitor to the common electrode.

### SUMMARY

One exemplary embodiment of the present invention, therefore, provides an LCD device that performs a dot inversion using a storage line which is separate from a common electrode line.

Another exemplary embodiment of the present invention provides a method of driving an LCD device which performs a dot inversion using a storage line provided separately from a common electrode line.

In an exemplary embodiment of the present invention, an LCD device includes: a pixel for displaying an image; a scan line for supplying a scan signal to the pixel; a data line crossing the scan line and for supplying a data signal to the pixel; a common electrode line for supplying a common voltage to the pixel; and a storage line disposed in parallel with the scan line and for performing a dot inversion.

In another exemplary embodiment of the present invention, an LCD device includes: a TFT having a gate connected to a scan line, a first electrode connected to a data line, and a second electrode adapted to receive a data signal applied to the data line through a channel; a liquid crystal disposed between a pixel electrode connected to the second electrode of the TFT and a common electrode of a common electrode line; and a storage capacitor connected between the second electrode of the TFT and a storage line, and for storing the data signal.

In still another exemplary embodiment of the present invention, a method of driving an LCD device includes: turning on a TFT and storing a first data voltage applied through a data line as a first pixel voltage in a storage capacitor; turning off the TFT and increasing the first pixel voltage according to a first storage voltage applied through a storage line provided separately from a common electrode line; turning on the TFT and storing a second data voltage applied through the data line as a second pixel voltage in the storage capacitor; and turning off the TFT and decreasing the second pixel voltage according to a second storage voltage applied through the storage line.

### BRIEF DESCRIPTION OF THE DRAWINGS

The accompanying drawings, together with the specification, illustrate exemplary embodiments of the present invention, and, together with the description, serve to explain the principles of the invention.

FIG. 1 is a circuit diagram of an LCD device according to an exemplary embodiment of the present invention;

FIG. 2 is a circuit diagram of a pixel driving circuit according to an exemplary embodiment of the present invention;

FIG. 3 is a timing diagram showing signals for operating a pixel driving circuit according to an exemplary embodiment of the present invention;

FIG. 4 is a timing diagram showing signals for operating an LCD device according to an exemplary embodiment of the present invention; and

FIG. 5 is a diagram illustrating a layout of an LCD device according to an exemplary embodiment of the present invention.

### DETAILED DESCRIPTION

Hereinafter, exemplary embodiments of the present invention will be described with reference to the accompanying drawings.

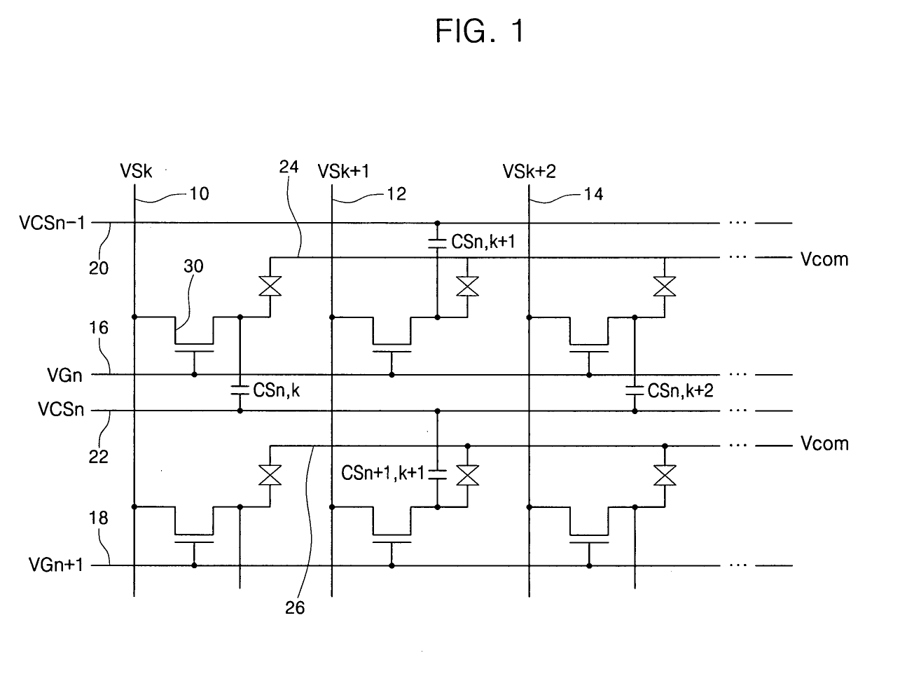

FIG. 1 is a circuit diagram of an LCD device according to an exemplary embodiment of the present invention.

Referring to FIG. 1, the LCD device includes a plurality of data lines 10, 12, 14 that extend in a vertical direction and receive data voltages VSk, VSk+1, VSk+2, respectively, and a plurality of scan lines 16, 18 that cross or cross over the data lines and receive scan signals VGn, VGn+1, respectively. Each data line is connected to a source driver, and each scan line is connected to a gate driver.

Further, each scan line is connected to a gate of a TFT 30 provided in a pixel, and each data line is connected to a first electrode of the TFT. The TFT 30 is turned on by a scan signal applied through the scan line, and thus a data signal is applied to a pixel electrode of the liquid crystal through the first electrode of the turned-on TFT. Therefore, an orientation of the liquid crystal molecules is determined by a difference between a data voltage applied to the pixel electrode and a common voltage (e.g., Vcom) applied to a common electrode. The orientation of the liquid crystal molecules determines the light transmittance of the liquid crystal, so that light passes through the liquid crystal and a color filter, thereby displaying a predetermined colored image.

Alternatively, a method of displaying an image according to an exemplary embodiment of the present invention may depend on a fast sequential (FS) driving method. That is, a backlight can include red, green and blue colored light emitting diodes (LEDs), and provide light to the liquid crystal having a predetermined light transmittance. In the LCD using the FS driving method, a color filter may not be used.

The pixel electrode is connected to a storage capacitor (e.g., CSn,k, Csn,k+1, CSn,k+1, CSn,k+2), and the storage capacitor is connected to a separate storage line 20, 22 without being connected to the common electrode. The storage line 20, 22 may be formed to extend in the same direction as the scan line 16, 18, and one storage line may be provided per scan line.

The n^{th} storage line 22 that receives an n^{th} storage signal VCSn is alternately connected to the storage capacitors of the TFTs connected to the n^{th} scan line 16. That is, the storage capacitor CSn,k is connected to the n^{th} storage line 22 to receive the storage signal VCSn, and the storage capacitor CSn,k+1 is connected to the (n−1 )^{th} storage line 20 to receive a storage signal VCSn−1. Likewise, the storage capacitor CSn,k+2 is connected to the n^{th} storage line 22. As described above, the storage capacitors are alternately connected to each storage line.

A common electrode line 24, 26 is commonly connected to a common electrode of the liquid crystal corresponding to each scan line. Hence, one common electrode line is provided per scan line. Also, the respective common electrode lines can be commonly connected to one node. That is, a common electrode voltage Vcom is applied to the common electrodes of all pixels.

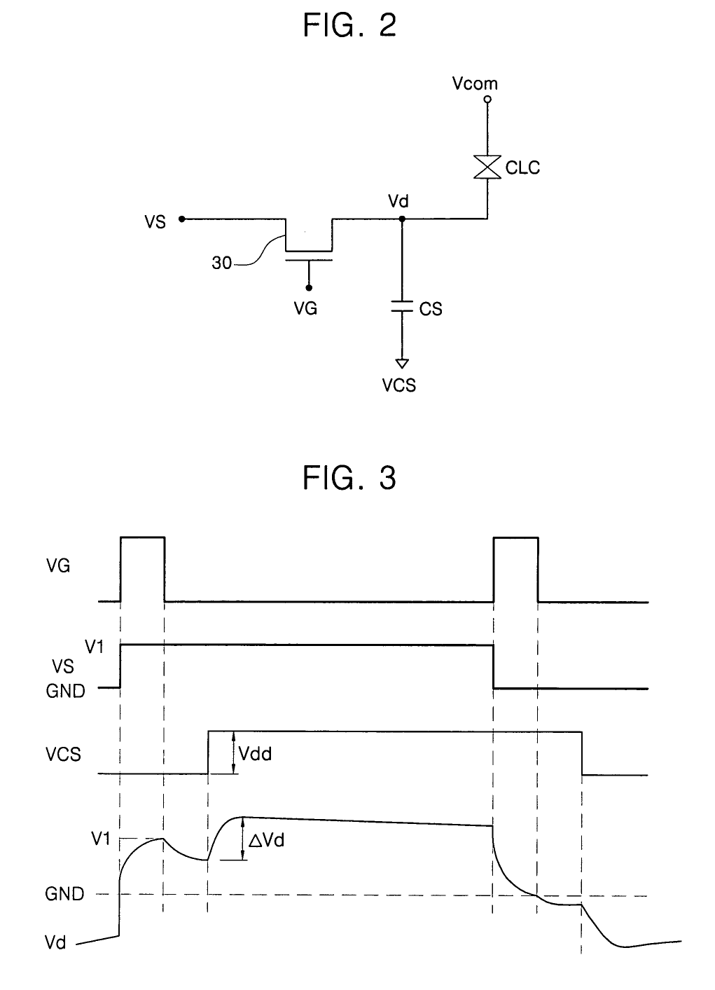

FIG. 2 is a circuit diagram of a pixel driving circuit according to an exemplary embodiment of the present invention.

Referring to FIG. 2, the pixel driving circuit includes a TFT 30, a storage capacitor CS connected to the TFT 30, and a liquid crystal CLC commonly connected to the TFT 30 and the storage capacitor CS.

The TFT 30 includes a gate electrode to receive a scan signal VG through a scan line, a first electrode to receive a data voltage VS, and a second electrode connected to the storage capacitor CS and the liquid crystal CLC. In a fabricating process of an LCD device, the second electrode of the TFT 30 forms a short circuit with a pixel electrode of the liquid crystal CLC. Hence, the voltage applied to the second electrode is equal to that applied to the pixel electrode.

The storage capacitor CS has a first terminal connected to the pixel electrode and/or the second electrode of the TFT 30, and a second terminal connected to a storage line. Here, a storage signal VCS is applied to the storage capacitor CS through the storage line.

The liquid crystal CLC is sandwiched (or disposed) between the pixel electrode and the common electrode. Here, a common voltage Vcom is applied to the common electrode through a common electrode line.

FIG. 3 is a timing diagram showing signals for operating the pixel driving circuit according to an exemplary embodiment of the present invention.

The operation of the pixel driving circuit Will be described below with reference to FIGS. 2 and 3.

When the scan signal VG is applied through the scan line, the TFT 30 of the pixel driving circuit connected to the scan line is turned on. Here, the TFT 30 is turned on when the scan signal VG having more than a threshold voltage is applied to the gate electrode of the TFT 30.

The data voltage applied to the first electrode of the TFT 30 is increased from a ground level GND to a predetermined level V1. As the voltage V1 is applied to the first electrode, the storage capacitor and the pixel electrode of the liquid crystal are electrically charged through a channel region of the TFT 30.

Further, the common electrode voltage Vcom is maintained at a constant DC level for at least one frame. The common electrode voltage Vcom should be maintained at a constant level without variation, and a gray scale of the liquid crystal CLC is achieved by changing the level of the data voltage. Thus, the level V1 of the data voltage varies depending on gray scales to be represented.

Also, the storage line is connected to the storage capacitor CS, and the storage signal VCS is applied to the storage capacitor CS through the storage line. While the TFT 30 is turned on, the storage signal VCS is maintained at a low level.

As the TFT 30 is turned on, the data voltage is applied to the storage capacitor CS and the pixel electrode of the liquid crystal CLC. Here, the voltage Vd applied to the pixel electrode is exponentially increased because of a capacitance of the storage capacitor CS and a capacitance of the liquid crystal CLC. The increasing rate of the voltage Vd applied to the pixel electrode depends on a time constant determined by the capacitance of the storage capacitor CS, the capacitance of the liquid crystal CLC, a resistance of the liquid crystal CLC, and the like. As a result, the voltage Vd applied to the pixel electrode is increased to the level V1 of the data voltage VS.

Then, the scan signal VG is decreased to a low level, and the TFT 30 is turned off. At this time, the electric charge supplied to the pixel electrode is interrupted by deactivation of the TFT 30. Further, the liquid crystal CLC and the storage capacitor CS are connected in series between the common electrode and the storage line. Thus, substantially equal amounts of electric charges are supplied to the pixel electrode of the liquid crystal CLS and the storage capacitor CS. Hence, charge sharing between the pixel electrode of the liquid crystal CLS and the storage capacitor is performed in the pixel electrode as the TFT 30 is turned off and the voltage Vd applied to the pixel electrode drops according to charge sharing.

Then, the storage signal VCS applied through the storage line is changed to a high level (e.g., by a voltage of Vdd) so that the voltage Vd of the pixel electrode increases. When the storage signal VCS has the voltage difference Vdd between its low and high levels, an increased variance ΔVd of the voltage Vd applied to the pixel electrode can be represented by the following Equation 1:

$$Δ Vd = \frac{CS}{CS + CLC} Vdd , \qquad < Equation 1 >$$

where CS indicates the capacitance of the storage capacitor, and CLC indicates the capacitance of the liquid crystal.

The voltage Vd applied to the pixel electrode is increased according to Equation 1, and the orientation of the liquid crystal molecules is determined by the voltage Vd of the pixel electrode and the voltage Vcom of the common electrode. Thus, when light is applied by a backlight to the liquid crystal having a predetermined orientation, a predetermined image is displayed.

While an image corresponding to one frame is displayed, the orientation of the liquid crystal molecules corresponding to one pixel should be maintained. That is, the voltage Vd of the pixel electrode should be maintained at a constant level. In practice, the voltage Vd of the pixel electrode drops slightly due to leakage current and the like as time goes by, however this voltage drop is typically negligible.

When an image corresponding to one frame is completely displayed, the TFT 30 is turned on, thereby performing dot inversion. The dot inversion is a process of inverting the polarity of voltage applied to the liquid crystal between the pixel electrode and the common electrode.

When the scan signal having more than a threshold voltage is applied to the gate electrode of the TFT 30, the TFT 30 is turned on. As the TFT 30 is turned on, the data voltage VS applied to the first electrode of the TFT 30 drops to the low level. The low level of the data voltage VS may be the ground level GND, for example. Here, the data voltage VS can drop to the low level at the same time that the TFT 30 is turned on, just before the TFT 30 is turned on, or after the TFT 30 is turned on.

When the TFT 30 receives the data voltage VS having the ground level as it is turned on, an electric charge stored at the pixel electrode is transferred to the data line via a channel region of the TFT 30. Thus, the voltage Vd of the pixel electrode drops down to the ground level. Here, the voltage Vd of the pixel electrode drops exponentially depending on the time constant of the pixel electrode.

Then, the electric charge (or current) flowing from the pixel electrode to the data line via the TFT 30 is interrupted by turning the TFT 30 off, so that the charge sharing is performed. As the electric charge is rearranged by the charge sharing, the voltage of the pixel electrode decreases further.

Then, the storage signal VCS transferred through the storage line drops down to the low level. As the storage signal VCS drops, the voltage Vd of the pixel electrode also drops. The dropped voltage of the pixel electrode causes the voltage of the pixel electrode to be inverted with respect to the voltage of the common electrode. Thus, the dot inversion is performed.

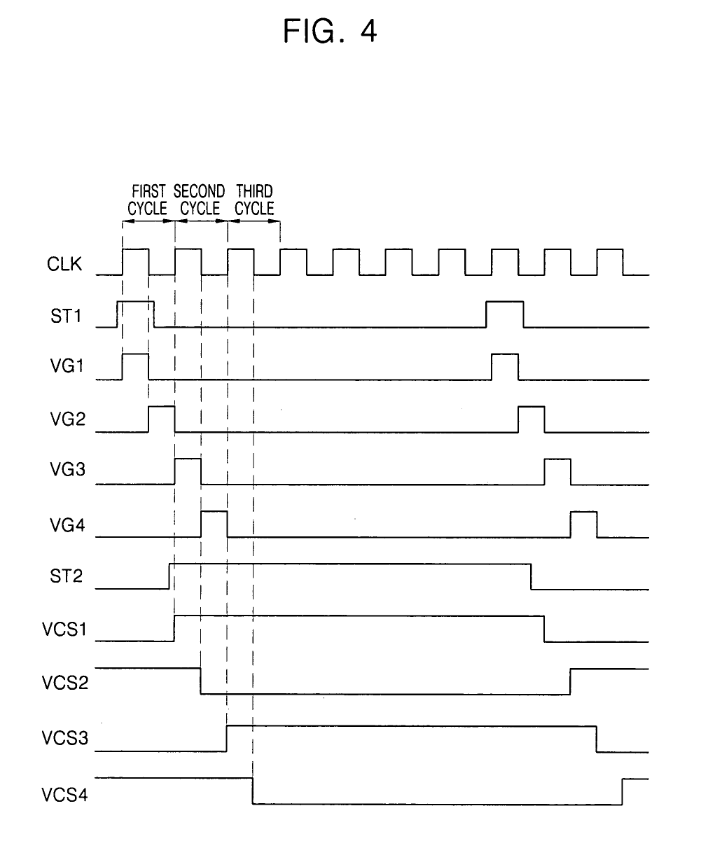

FIG. 4 is a timing diagram showing signals for operating an LCD device according to an exemplary embodiment of the present invention.

Referring to FIG. 4, a scan start pulse ST1 is input in synchronization with a clock signal CLK. The scan start pulse ST1 is input to a gate driver, and thus the gate driver generates a plurality of scan signals by sampling the input scan start pulse ST1. In FIG. 4, the gate driver samples the scan start pulse ST1 at a rising edge of the clock signal CLK, but is not limited thereto. Alternatively, the gate driver may sample the scan start pulse ST1 at a falling edge of the clock signal CLK.

The gate driver includes shift registers to generate the scan signals in sequence. Thus, each scan signal is delayed by a half clock with regard to the previous scan signal and then output. Alternatively, each scan signal may be delayed by one clock with respect to the previous scan signal and then output according to the configuration of the shift register.

A first scan signal VG1 is output at a rising edge in a first cycle of the clock signal CLK, and a second scan signal VG2 is output at a falling edge in the first cycle of the clock signal CLK.

Further, a storage start pulse ST2 is sampled at a rising edge in a second cycle of the clock signal CLK and output. Here, the gate driver can be used to sample the storage start pulse ST2 and generate a storage signal. Alternatively, a separate driver may be used to sample the storage start pulse ST2 and generate the storage signal.

A first storage signal VCS1 is changed to a high level at a rising edge in the second cycle of the clock signal CLK and maintained in the high level for one frame. Further, a second storage signal VCS2 is changed to a low level at a falling edge in the second cycle of the clock signal CLK and maintained in the low level for one frame. The first storage signal VCS1 is maintained in the high level for one frame and then maintained in the low level for the next frame, thereby performing the dot inversion. Likewise, the second storage signal VCS2 is maintained in the low level for one frame and then maintained in the high level for the next frame, thereby performing the dot inversion. Further, third and fourth scan signals VG3, VG4 and third and fourth storage signals VCS3, VCS4 are applied in a similar manner as the first and second scan signals VG1, VG2 and the first and second storage signals VCS1 and VCS2 to perform the dot inversion.

According to an exemplary embodiment of the present invention, each storage signal is applied to the storage capacitor through the storage line provided independently of the common electrode line.

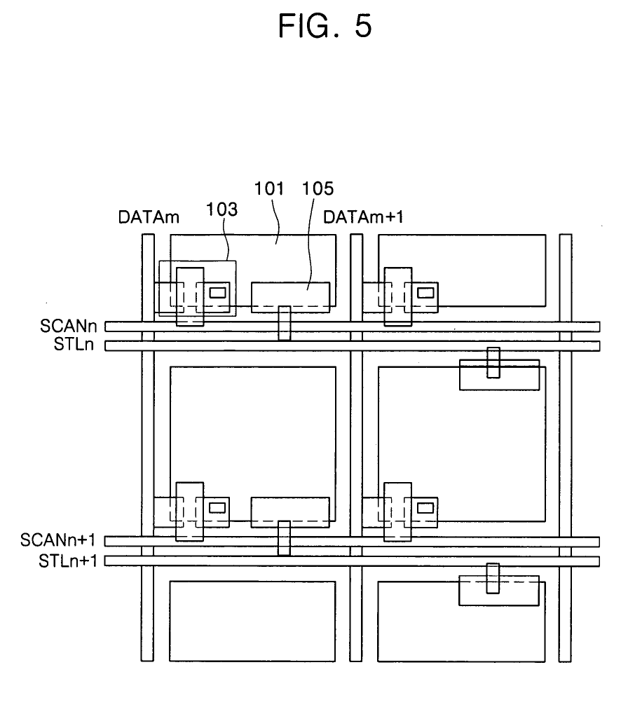

FIG. 5 illustrates a layout of an LCD device according to an exemplary embodiment of the present invention.

Referring to FIG. 5, the LCD device includes a plurality of pixels. Each pixel is connected to a data line DATA (e.g., DATAm or DATAm+1) and a scan line SCAN (e.g., SCANn or SCANn+1). Here, the data line DATA is connected to a source driver (not shown) and the scan line SCAN is connected to a gate driver (not shown). Further, each pixel is connected to a storage line STL (e.g., STLn or STLn+1). The storage line STL is connected to a storage capacitor 105 and supplies a storage signal. Also, the storage line STL is arranged in parallel with the scan line SCAN and may be connected either to the gate driver or to a separate driver. The pixels coupled to one of the scan lines (e.g., SCANn+1) is alternately coupled to a storage line (e.g., STLn+1) which is below the one of the scan lines or a storage line (e.g., STLn) which is above the one of the scan lines.

The n^{th} scan line SCANn is connected to a gate of a TFT 103 provided in the pixel. The TFT 103 includes a first electrode connected to the n^{th} data line DATAn. The data line DATAn is formed to cross or cross over with the scan line SCANn.

Further, the n^{th} storage line STLn is connected to a storage capacitor 105, which is connected to a pixel electrode of a liquid crystal 101. In FIG. 5, the storage line STLn is connected to an upper electrode of the storage capacitor 105 through a contact, and a lower electrode of the storage capacitor 105 is connected to the pixel electrode of the liquid crystal 101 through a contact. The arrangement and configuration method of the electrodes of the storage capacitor 105 using one or more contacts may vary with the embodiment.

The storage line STLn is alternately connected to the storage capacitor of the upper pixel and the storage capacitor of the lower pixel with respect to the storage line STLn. For example, when the storage capacitors of the pixels corresponding to even numbered columns among the upper pixels are connected to the storage line STLn, the storage capacitors of the pixels corresponding to odd numbered columns among the lower pixels are connected to the storage line STLn.

As described above, the storage line is provided separately from the common electrode line, so that the storage signal applied to the storage line is varied once per frame, thereby performing the dot inversion.

According to an exemplary embodiment of the present invention, a storage line is provided separately from a common electrode line, and a storage signal is varied once per frame, thereby performing the polarity inversion of voltage applied to a liquid crystal of a pixel. Therefore, compared to when the dot inversion is performed using the common electrode line, variation of the applied voltage used in performing the dot inversion is decreased, and thus a power consumption for performing the dot inversion is reduced.

It will be apparent to those skilled in the art that various modifications and variation can be made in the present invention without departing from the spirit or scope of the invention. Thus, it is intended that the present invention cover the modifications and variations of the invention that come within the scope of the appended claims and their equivalents.

What is claimed is:

1. A liquid crystal display (LCD) device comprising:
a pixel for displaying an image;
a scan line for supplying a scan signal to the pixel;
a data line crossing the scan line and for supplying a data signal to the pixel;
a common electrode line for supplying a common voltage to the pixel; and
a storage line disposed in parallel with the scan line and for performing a dot inversion.

2. The LCD device of claim 1, wherein the pixel comprises:
a thin film transistor (TFT) for performing an on/off operation in response to the scan signal and having a first electrode to receive the data signal and a second electrode;
a storage capacitor connected between the second electrode of the TFT and the storage line and for storing the data signal; and
a liquid crystal disposed between a pixel electrode connected to the second electrode of the TFT and a common electrode.

3. The LCD device of claim 2, wherein a storage voltage applied through the storage line alternates between a high level and a low level once per frame of the image.

4. The LCD device of claim 3, wherein the common voltage is maintained at a predetermined level for one frame of the image.

5. The LCD device of claim 3, wherein the data signal repeats a level shift once per frame of the image.

6. The LCD device of claim 5, wherein the storage capacitors of the pixels connected to the scan line are alternately connected to two storage lines placed above and below the pixels.

7. A liquid crystal display (LCD) device comprising:
a thin film transistor (TFT) having a gate connected to a scan line, a first electrode connected to a data line, and a second electrode adapted to receive a data signal applied to the data line through a channel;
a liquid crystal disposed between a pixel electrode connected to the second electrode of the TFT and a common electrode of a common electrode line; and
a storage capacitor connected between the second electrode of the TFT and a storage line, and for storing the data signal.

8. The LCD device of claim 7, wherein a storage voltage applied through the storage line alternates between a high level and a low level once per frame of the image.

9. The LCD device of claim 8, wherein a common voltage applied to the common electrode is maintained at a predetermined level for one frame of the image.

10. The LCD device of claim 8, wherein the data signal repeats a level shift once per frame of the image.

11. A method of driving a liquid crystal display (LCD) device, comprising:
turning on a thin film transistor (TFT) and storing a first data voltage applied through a data line as a first pixel voltage in a storage capacitor;
turning off the TFT and increasing the first pixel voltage according to a first storage voltage applied through a storage line provided separately from a common electrode line;
turning on the TFT and storing a second data voltage applied through the data line as a second pixel voltage in the storage capacitor; and
turning off the TFT and decreasing the second pixel voltage according to a second storage voltage applied through the storage line.

12. The method of claim 11, wherein the first data voltage is higher than the second data voltage.

13. The method of claim 12, wherein the first storage voltage is higher than the second storage voltage.

14. The method of claim 13, further comprising, after increasing the first pixel voltage according to the first storage voltage, maintaining the increased first pixel voltage.

15. The method of claim 13, wherein increasing the first pixel voltage according to the first storage voltage comprises:
rearranging an electric charge stored in the storage capacitor; and
applying the first storage voltage to the storage capacitor that stores the rearranged electric charge.

16. The method of claim 15, wherein decreasing the second pixel voltage according to the second storage voltage comprises:
rearranging an electric charge stored in the storage capacitor; and
applying the second storage voltage to the storage capacitor that stores the rearranged electric charge.
